(19) United States
(12) Patent Application Publication
(10) Pub. No.: US 2024/0088803 A1
(43) Pub. Date: Mar. 14, 2024

(54) A CHARGED MOTOR APPLYING RETARDED ELECTROMAGNETIC FIELDS

(71) Applicant: ARIEL SCIENTIFIC INNOVATIONS LTD., Ariel (IL)

(72) Inventor: Asher YAHALOM, Givaat Shmuel (IL)

(21) Appl. No.: 18/262,558

(22) PCT Filed: Jan. 19, 2022
(86) PCT No.: PCT/IL2022/050080

§ 371 Date: Jul. 21, 2023

Related U.S. Application Data
(60) Provisional application No. 63/140,873, filed on Jan. 24, 2021.

(51) Int. Cl. H02N 11/00

(52) U.S. Cl. CPC H02N 11/006

(57) ABSTRACT

A charged motor is configured to apply a retarded electromagnetic field to generate a force. The charged motor has a first element having a non-zero charge density and a second element having a non-zero current density (I). The interaction of the charge density and the current density generates a force (II) and a momentum (III).

### FIELD OF THE INVENTION

The present invention relates to the fields of motors and arrangements for handling mechanical energy.

### BACKGROUND

Building on the work of James Maxwell [Ref. 9] and Oliver Heaviside [Ref. 12], Einstein postulated that fields cannot travel faster than the speed of light [Ref. 8]. Because of this limitation, a force generated from a distance R arrives at a target after a retardation time of at least

$$\frac{R}{c} .$$

Locomotive systems of today are commonly based on two material parts each obtaining momentum which is equal and opposite, abiding by Newton's third law that when one body exerts a force on a second body, the second body simultaneously exerts a force equal in magnitude and opposite in direction on the first body [Ref. 13]. A typical example is a rocket that sheds exhaust gas to propel itself. Recent work on “relativistic engines” indicates that, due to the retardation time of electromagnetic fields, equal and opposite momentum may be provided not between two material bodies but between a material body and a field. As described by Tuval, et al. [Ref. 4], momentum gained by a material body may have an opposite amount of momentum obtained by the field.

Noether's theorem dictates that any system possessing translational symmetry will conserve momentum and the total physical system containing matter and field is indeed symmetrical under translations, while sub-systems (either matter or field) are not. This was noted also by Feynman [Ref. 11], who described two orthogonally moving charges, where the forces that the moving charges induced on each other did not cancel (last part of Feynman Lectures 26-2). Feynman showed in Section 27-6 of his Lectures that the momentum gained by a two charge system is balanced by the field momentum.

Griffiths and Heald [Ref. 16] pointed out that Coulomb's law and the Biot-Savart law determine the electric and magnetic fields for static sources only. Time-dependent generalizations of these two laws were introduced by Jefimenko [Ref. 17] who explored the applicability of Coulomb and Biot-Savart outside the static domain.

A paper by the present inventors [Ref. 1] applied Jefimenko's equations [cited in Refs. 10 and 17] to understand the force between two current carrying coils. The interaction between a current carrying loop and a permanent magnet was subsequently developed [Refs. 2, 3]. Because the system is affected by a total force for a finite period of time, the system acquires mechanical momentum and energy. Yahalom [Ref. 5] and subsequently Rajput and Yahalom [Refs. 6, 7] investigated the exchange of energy between the mechanical part of a relativistic motor and the electromagnetic field. In particular it was shown that the electric energy expenditure is twice the kinetic energy gained by the relativistic motor. Such analysis relied on the fact that the bodies were macroscopically natural, that is the number of electrons and ions was equal in every volume element.

### SUMMARY

Embodiments of the present invention provide a system and methods whereby a charged motor generates a force and momentum, due to the retardation time of electromagnetic fields. The charged motor has a first element with a non-zero charge density and a second element having a non-zero current density \vec{J}₂. The interaction of the charge density and the current density causes the charged motor to generate a force \vec{F}_{T}, which may also generate a momentum \vec{P}(t).

Hereinbelow, the terms “motor” and “engine” are used interchangeably. A charged motor, also referred to herein as a charged, “relativistic” motor, is a motor configured to apply retardation of electromagnetic fields so as to achieve the following advantages over typical motors that provide mechanical force:
generates 3-axis motion (including vertical);
has no moving parts;
requires zero fuel consumption;
has zero carbon emission;
needs only a source for generating electromagnetic energy (which may be acquired by photovoltaic panels).
can convert kinetic energy back to electromagnetic energy, for energy storage, making the motor highly efficient.

Consequently a “charged motor” as described herein is well suited for changing the momentum of a space vehicle, as the charged motor would reduce or obviate the space vehicle's need for consumable fuel. In principle, kinetic energy of the motor could also be converted back to electromagnetic energy for optimal efficiency. Similar benefits may apply to use of the relativistic motor for ground, sea, air, and space transportation. As described below, a microscopic distribution of periodic charge density, accompanied by a current density distribution of the same period, may also enable a relativistic motor that can be manipulated in three axes.

### BRIEF DESCRIPTION OF DRAWINGS

For a better understanding of various embodiments of the invention and to show how the same may be carried into effect, reference will now be made, by way of example, to the accompanying drawings. Structural details of the invention are shown to provide a fundamental understanding of the invention, the description, taken with the drawings, making apparent to those skilled in the art how the several forms of the invention may be embodied in practice. In the accompanying drawings:

FIG. 1A is a schematic diagram of an exemplary relativistic motor, according to some embodiments of the invention;

FIG. 1B is a schematic side view of electrical and mechanical elements of the exemplary relativistic motor, according to some embodiments of the invention; and

FIGS. 2 and 3 are graphs of a function \tilde{Λ}, used in the equation for momentum,

$$\vec{P} = \frac{{μ}_{0}}{4 π} σ {J}_{0} {wab}^{2} \tilde{Λ} ( {a}^{′} , {b}^{′} ) \hat{x} ,$$

as described further hereinbelow, according to some embodiments of the invention.

### DETAILED DESCRIPTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### Relevant Computational Analysis

Consider two bodies having volume elements d³x₁, d³x₂ located at \vec{x}₁, \vec{x}₂ respectively, and having charge densities ρ₁, ρ₂. When an electric field \vec{E} and magnetic field \vec{B} are created by a charged body 1 acting upon charged body 2, the Lorentz force is given as:

\vec{F}₂₁=∫d³x₂ρᵢ₂(\vec{E}+\vec{v}ᵢ₂×\vec{B})+∫d³x₂ρₑ₂(\vec{E}+\vec{v}ₑ₂×\vec{B})

where ρᵢ₂ and ρₑ₂ are the ion charge density and electron charge density respectively, ˜vᵢ₂ and ˜vₑ₂ are the ion velocity field and electron velocity field respectively. The total charge density is the sum of the ions charge density and free electrons charge density, hence:

ρ₂=ρᵢ₂+ρₑ₂. (2)

Thus the electric terms in the above force equation cancel, such that:

\vec{F}₂₁=∫d³x₂ρ₂\vec{E}+∫d³x₂ρᵢ₂\vec{v}ᵢ₂×\vec{B}+∫d³x₂ρₑ₂\vec{v}ₑ₂×\vec{B}. (3)

For a current density: \vec{J}₂=ρₑ₂\vec{v}ₑ₂, the above equation may be written:

\vec{F}₂₁=∫d³x₂(ρ₂\vec{E}+\vec{J}₂×\vec{B}) (4)

When a coil generates the magnetic field, the electric and magnetic fields can be written as follows in terms of the vector and scalar potentials:

\vec{E}=−∂ₜ\vec{A}−\vec{∇}Φ (5)

\vec{B}=∇×\vec{A} (6)

In the above ∇˜ has the standard definition used in vector analysis, t is time and ∂ₜ is a partial derivative with respect to time. If the field is generated by a charge density ρ₁ and current density \vec{J}₁ in charged body 1, the scalar and vector potentials are indicated by Jackson [10]:

$$Φ ( {\vec{x}}_{2} ) = \frac{1}{4 π {ϵ}_{0}} \int {d}^{3} {x}_{1} \frac{{ρ}_{1} ( {\vec{x}}_{1} , {t}_{ret} )}{R} \\ where , \vec{R} ≡ {\vec{x}}_{12} , {t}_{ret} ≡ t - \frac{R}{c} ,$$

ε₀ is the vacuum permittivity, i.e., the absolute dielectric permittivity of a vacuum, approximately 8.85×10⁻¹² F·m⁻¹,
and

$$\vec{A} ( {\vec{x}}_{2} ) = \frac{{μ}_{0}}{4 π} \int {d}^{3} {x}_{1} \frac{{\vec{J}}_{1} ( {\vec{x}}_{1} , {t}_{ret} )}{R} .$$

The magnetic field may be described by Jefimenko's equations [Refs. 10, 17]:

$$\vec{B} ( {\vec{x}}_{2} ) = \frac{{μ}_{0}}{4 π} \int {d}^{3} {x}_{1} \frac{\vec{R}}{{R}^{3}} \times ( {\vec{J}}_{1} ( {\vec{x}}_{1} , {t}_{ret} ) + ( \frac{R}{c} ) {\partial }_{t} {\vec{J}}_{1} ( {\vec{x}}_{1} , {t}_{ret} ) ) \qquad ( 7 )$$

(The magnetic constant μ₀, also known as the vacuum permeability or the permeability of free space and is approximately 1.257×10⁻⁶ H/m.)
For the electric field there are two contributions according to equation (5), one from the scalar potential and a second one from the vector potential:

\vec{E}=\vec{E}ₐ+\vec{E}_{b}, \vec{E}ₐ≡−∂ₜ\vec{A}, \vec{E}_{b}≡−\vec{∇}Φ.

These definitions also lead to Jefimenko's expression [10, 17] for the electric field:

$$\vec{E} ( {\vec{x}}_{2} ) = - k \int {d}^{3} {x}_{1} \frac{1}{{R}^{2}} [ ( {ρ}_{1} ( {\vec{x}}_{1} , {t}_{ret} ) + ( \frac{R}{c} ) {\partial }_{t} {ρ}_{1} ( {\vec{x}}_{1} , {t}_{ret} ) ) \hat{R} + {( \frac{R}{c} )}^{2} \frac{{\partial }_{t} {\vec{J}}_{1} ( {\vec{x}}_{1} , {t}_{ret} )}{R} ] . \qquad ( 8 )$$

Inserting equation (7) and equation (8) into equation (4), the equation for force may be written as:

$${\vec{F}}_{21} = - k \int \int {d}^{3} {x}_{1} {d}^{3} {x}_{2} \frac{1}{{R}^{2}} \{ {ρ}_{2} ( {\vec{x}}_{2} , t ) [ ( {ρ}_{1} ( {\vec{x}}_{1} , {t}_{ret} ) + \qquad ( 9 )$$

$$( \frac{R}{c} ) {\partial }_{t} {ρ}_{1} ( {\vec{x}}_{1} , {t}_{ret} ) ) \hat{R} + {( \frac{R}{c} )}^{2} \frac{{\partial }_{t} {\vec{J}}_{1} ( {\vec{x}}_{1} , {t}_{ret} )}{R} ] +$$

$${( \frac{R}{c} )}^{2} [ \frac{\hat{R}}{{R}^{2}} \times ( {\vec{J}}_{1} ( {\vec{x}}_{1} , {t}_{ret} ) + ( \frac{R}{c} ) {\partial }_{t} {\vec{J}}_{1} ( {\vec{x}}_{1} , {t}_{ret} ) ) ] \times {\vec{J}}_{2} ( {\vec{x}}_{2} , t ) \}$$

Consider the charge density

$$\\ ρ ( \vec{x} {}^{′} , {t}_{ret} ) = ρ ( \vec{x} {}^{′} , t - \frac{R}{c} ) , if \frac{R}{c}$$

is small but not zero a Taylor series expansion around t has the form:

$$ρ ( {\vec{x}}^{′} , {t}_{ret} ) = ρ ( {\vec{x}}^{′} , t - \frac{R}{c} ) = {\sum }_{n = 0}^{∞} \frac{{\partial }_{t}^{n} ρ ( {\vec{x}}^{′} , t )}{n !} {( - \frac{R}{c} )}^{n} \qquad ( 10 )$$

where ∂ₜⁿJ˜(˜x′,t) is the partial temporal derivative of order n of J˜(˜x′,t). The same expansion for the current density leads to the expression:

$$\vec{J} ( {\vec{x}}^{′} , {t}_{ret} ) = \vec{J} ( {\vec{x}}^{′} , t - \frac{R}{c} ) = {\sum }_{n = 0}^{∞} \frac{{\partial }_{t}^{n} \vec{J} ( {\vec{x}}^{′} , t )}{n !} {( - \frac{R}{c} )}^{n} \qquad ( 11 )$$

where ∂ₜⁿJ˜(˜x′,t) is the partial temporal derivative of order n of J˜(˜x,t).

A force at time t acting on the center of mass of two charge bodies having volume elements at positions x₁, x₂ respectively, with charge densities ρ₁ and ρ₂ and current densities \vec{J}₁ and \vec{J}₂ respectively, where \vec{R}≡\vec{x}₁₂=\vec{x}₁−\vec{x}₂, R≡|x₁−x₂|,

$$\hat{R} ≡ \frac{\vec{R}}{R} ,$$

is:

$${\vec{F}}_{T}^{[ 2 ]} = \frac{{μ}_{0}}{4 π} {\partial }_{t} \int \int {d}^{3} {x}_{1} {d}^{3} {x}_{2} [ \frac{1}{2} ( {ρ}_{2} {\partial }_{t} {ρ}_{1} - {ρ}_{1} {\partial }_{t} {ρ}_{2} ) \hat{R} - ( {ρ}_{1} {\vec{J}}_{2} + {ρ}_{2} {\vec{J}}_{1} ) {R}^{- 1} ] \qquad ( 12 )$$

where \vec{F}_{T}^{[2]} indicates a second order term of a Taylor series expansion around t. (Note the notation,

$${\partial }_{t} ≡ \frac{\partial }{\partial t} . )$$

Given that \vec{F}_{T}^{[0]} and \vec{F}_{T}^{[1]} are null, and that higher order terms of \vec{F}_{T}^{[n]} are neglible, the force may be written as;

$${\vec{F}}_{T} ≅ \frac{{μ}_{0}}{4 π} {\partial }_{t} \int \int {d}^{3} {x}_{1} {d}^{3} {x}_{2} [ \frac{1}{2} ( {ρ}_{2} {\partial }_{t} {ρ}_{1} - {ρ}_{1} {\partial }_{t} {ρ}_{2} ) \hat{R} - ( {ρ}_{1} {\vec{J}}_{2} + {ρ}_{2} {\vec{J}}_{1} ) {R}^{- 1} ] \qquad ( 13 )$$

A system with a non-zero total force in its center of mass must have a change in its total linear momentum \vec{P}(t) such that:

$${\vec{F}}_{T}^{[ 2 ]} = \frac{d \vec{P}}{dt} \qquad ( 14 )$$

according to Newton's second law.

Assuming that \vec{P}(−∞)=0, and also that there are no current or charge densities at t=−∞, it follows from equation (13) that:

$$\vec{P} ( t ) = \frac{{μ}_{0}}{4 π} \int \int {d}^{3} {x}_{1} {d}^{3} {x}_{2} [ \frac{1}{2} ( {ρ}_{2} {\partial }_{t} {ρ}_{1} - {ρ}_{1} {\partial }_{t} {ρ}_{2} ) \hat{R} - ( {ρ}_{1} {\vec{J}}_{2} + {ρ}_{2} {\vec{J}}_{1} ) {R}^{- 1} ] \qquad ( 15 )$$

Comparing equation (15) with the momentum gain of a non-charged relativistic motor described by equation (64) of [Ref. 4]:

$${\vec{P}}_{mech} ≅ \frac{{μ}_{0}}{8 π} {\partial }_{t} {I}_{1} ( t ) {{I}_{2} ( \frac{h}{c} )}^{2} {\vec{K}}_{122} , {\vec{K}}_{122} = - \frac{1}{{h}^{2}} ∮ ∮ \hat{R} ( d {\vec{l}}_{2} \cdot d {\vec{l}}_{1} ) \qquad ( 16 )$$

in which h is a typical scale of the system, I₁(t) and I₂ are the currents flowing through two current loops and d\vec{I}₁, d\vec{I}₂ are the current loop line elements. First, note that in the case of an uncharged motor there is a factor of

$${( \frac{h}{c} )}^{2} ,$$

and given that for any practical system the scale h is of the order of one, this means that the charged motor is stronger than the uncharged motor by a factor of c²˜10¹⁷. Second, note that for the uncharged motor the current must be continuously increased in order to maintain the momentum in the same direction. As the momentum cannot be increased forever, the uncharged motor must operate as a piston engine creating a periodic motion backward and forward and can only produce motion forward by interacting with an external system (such as a road). This is not the case for the charged motor. Rather, the charged motor can obtain non-vanishing momentum for stationary charge and current densities, as indicated by the following momentum equation:

$$\vec{P} ( t ) = - \frac{{μ}_{0}}{4 π} \int \int {d}^{3} {x}_{1} {d}^{3} {x}_{2} ( {ρ}_{1} {\vec{J}}_{2} + {ρ}_{2} {\vec{J}}_{1} ) {R}^{- 1} . \qquad ( 17 )$$

Hence the charged motor produces forward momentum without interacting with any external system except its own electromagnetic field. The above expression can be somewhat simplified using the non-retarded scalar potentials defined as:

$$Φ ( {\vec{x}}_{2} ) = \frac{1}{4 π {ε}_{0}} \int {d}^{3} {x}_{1} \frac{{ρ}_{1} ( {\vec{x}}_{1} , t )}{R} , .$$

such that:

$$\vec{P} ( t ) = - \frac{1}{{c}^{2}} [ \int {d}^{3} {x}_{2} {Φ}_{1} {\vec{J}}_{2} + \int {d}^{3} {x}_{1} {Φ}_{2} {\vec{J}}_{1} ] \qquad ( 18 )$$

in which

$$\frac{{μ}_{0}}{4 π k} = {μ}_{0} {ε}_{0} = \frac{1}{{c}^{2}} .$$

Another observation is that in a charged motor we do not need both subsystems to be charged to achieve momentum, in fact if ρ₂=0, then

$$\vec{P} ( t ) = - \frac{{μ}_{0}}{4 π} \int \int {d}^{3} {x}_{1} {d}^{3} {x}_{2} {ρ}_{1} {\vec{J}}_{2} {R}^{- 1} = - \frac{1}{{c}^{2}} \int {d}^{3} {x}_{2} Φ {\vec{J}}_{2} \qquad ( 19 )$$

provided that the system has a non-vanishing current density \vec{J}₂. As in the “relativisitic engine” described by Tuval and Yahalom [Ref. 4], the forward momentum gained by the mechanical system will be balanced by a backward momentum gained by the electromagnetic system. Optimization of the motor to generate momentum requires optimization of the charge density and of the current density, as described in the following sections.

### Charge Density Analysis

The amount of charge that can be accumulated in a given volume or surface is limited by the phenomena of electrical breakdown in which the surrounding medium is separated into electron and ions and becomes a plasma. As the surrounding becomes conductive a discharge occurs and the charge density is reduced. The dielectric strength Eₘₐₓ of air is 3 MV/m, for high vacuum 20-40 MV/m, and for diamond 2000 MV/m [Refs. 18-20]. For an infinite surface the surface density σ is:

σ=2ϵE<σₘₐₓ=2ϵEₘₐₓ, ϵ=ϵᵣϵ₀ (20)

in which ϵᵣ is the relative susceptibility. For air σₘₐₓ≃53 μC/m². To estimate the amount of charge Q which can be maintained in a given volume, note that for a spherical symmetric charge ball, at a distance r, the radial field E is:

$$E = \frac{k Q}{{r}^{2}} \qquad ( 21 )$$

the stronger field is on the ball itself, that is at r=rₛ, therefore:

$$\frac{k Q}{{r}_{s}^{2}} < {E}_{m} ⇒ Q < {Q}_{m} = \frac{1}{k} {r}_{s}^{2} {E}_{m} \qquad ( 22 )$$

For a ball having a size of 1 m, the maximal charge is 3.310⁻⁴ C. Hence, regardless of whether there is a surface charge or a volume charge, the maximal charge scales as the square of the dimension of the system, that is as h². A possible approach to increase the available charge density is to use an electret. Fluorinated parylene (Parylene HT, SCS) offers excellent surface charge density of 3.7 mC/m², found for a 7.3 μm film described by Hsi-wen and Yu-Chong [Ref. 21], this material has a dielectric strength of 204.58 MV/m. However, as the thickness of the material grows the charge density is reduced.

### Current Density Analysis

The amount of current a device can generate depends on its voltage and internal resistance. Provided that the external impedance is not significant the resulting currents are denoted as short currents and can be of the order of a few thousand amperes for a standard domestic mains electrical installation, or as high as hundreds of thousands of amperes in large industrial power systems. If the current is flowing through a metal conductor then heat will generated due to the finite resistivity of the conductor. Large currents require thick conductors in order to avoid excessive heating. This problem can be circumvented by using a superconductor, although this will require cooling to extremely low temperature, making the system quite cumbersome. But even a superconductor has a critical current density above which a superconductor will lose its superconduction properties. Jung, S. G. et al. [Ref. 22] have reported critical current densities as high as 5 kA/cm². Coil windings enable reuse of the current, hence the number of windings in a given area are also critical to the performance of the system. Proximity of the current to the charge will also affect the amount of generated momenta indicated by equation (19); however, putting a conductor too close to the charge may result in discharge, hence a balance should be struck.

### Exemplary Implementation

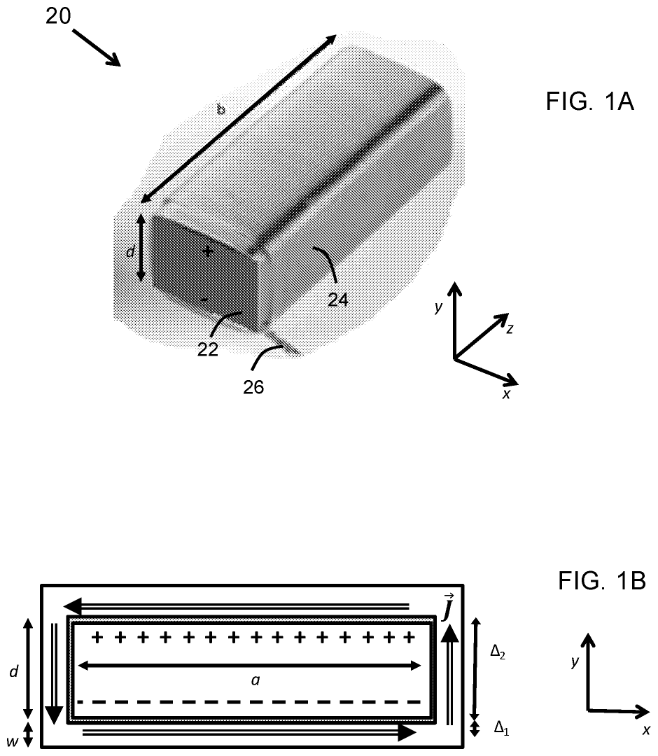

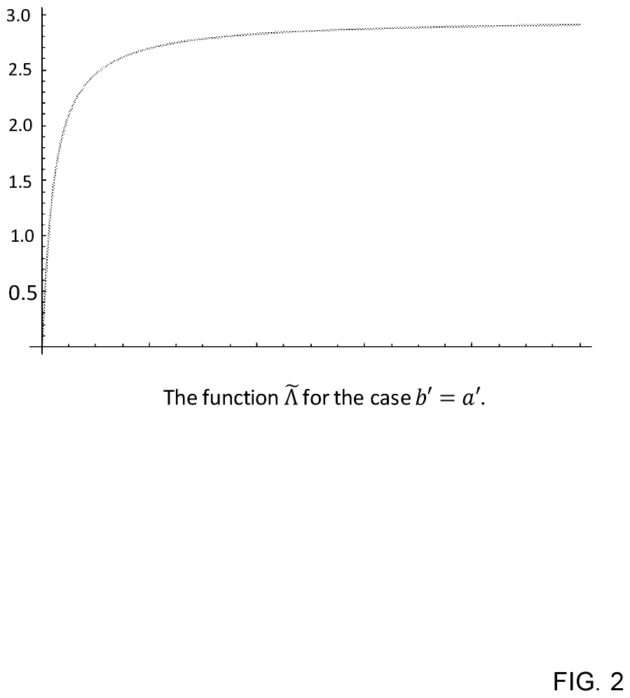

FIG. 1A is an orthogonal view of a charged motor 20, and FIG. 1B is a cross-sectional view of the charged motor 20, according to some embodiments of the invention. The charged engine includes a charged electret 22, having a thickness d and area of a×b, where the charge of the electret is imposed between the two sides of the thickness d. Typically, the thickness d of the electret is significantly smaller than the dimensions of a and b, such that the charged motor 20 has the form of a square plate.

The electret is positioned inside a tightly wound conducting coil 24. Loops of the coil encompass the electret as indicated in the cross section of FIG. 1B, such that the length of each loop is equal to twice the thickness d and twice the dimension a. The thickness d is indicated as the axis of the charge gradient of the electret. For convenience, the thickness d is labeled as the y axis, and the dimension a is labeled as the x axis (i.e., the dimension b is in the z axis, which may be viewed as a width of the engine).

The coils have a thickness indicated as w. In some embodiments coil 24 may be configured as a superconductive coil. A current having a current density indicated as \vec{J} flows through the coil, originating from a source connected to ends 26 of the coil. The current may be provided, for example, by photoelectric panels, obviating the need for fuel.

As the current in the x direction is close to the negative charge, it makes a considerable contribution to the momentum equation (19), whereas the return current, which is far away from the negative charge, will make a relatively small contribution. The situation is reversed with regard to the positive charge; here the return current will make the main contribution. Hence the total momentum contribution is doubled with respect to the current flowing in the x direction and interacting with negative charge alone. The current flowing in the y direction will not contribute to the momentum, as the contribution from the current flowing upwards is exactly balanced by the contribution of the current flowing downwards. This momentum may be calculated as follows.

Starting with the negative charge layer of FIG. 1B, we impart a surface charged layer in the plane y=0 with a surface charge density σ such that:

$${ρ}_{1} ( {x}_{1} , {y}_{1} , {z}_{1} ) = - σ δ ( {y}_{1} ) \{ \begin{matrix}1 & - \frac{a}{2} < {x}_{1} < \frac{a}{2} , - \frac{b}{2} < {z}_{1} < \frac{b}{2} \\ 0 & else\end{matrix} \qquad ( 23 )$$

in the above δ(y₁) is a Dirac delta.

$${\vec{J}}_{2} ( {x}_{2} , {y}_{2} , {z}_{2} ) = \hat{x} {J}_{0} w δ ( {y}_{2} + Δ ) \{ \begin{matrix}1 & - \frac{a}{2} < {x}_{2} < \frac{a}{2} , - \frac{b}{2} < {z}_{2} < \frac{b}{2} \\ 0 & else\end{matrix} \qquad ( 24 )$$

in which J₀ is the current density, w is the width of the winding, \hat{x} is a unit vector in the x direction and Δ is the distance of the current plane from the negative charge plane. (Obviously there is a difference between the Δ of the current Δ₁ and the return current Δ₂.) The integrated current flowing through the system is:

I=J₀ w b. (25)

However, the current flowing through each single wire depends on the winding number N_{w}:

$${I}_{c} = \frac{I}{{N}_{w}} \qquad ( 26 )$$

Plugging equation (25) and equation (26) into equation (19), the momentum may be represented by the equation:

$$\vec{P} = \frac{{μ}_{0}}{4 π} σ {J}_{0} w \hat{x} {\int }_{- \frac{a}{2}}^{+ \frac{a}{2}} {dx}_{1} {\int }_{- \frac{b}{2}}^{+ \frac{b}{2}} {dz}_{1} {\int }_{- \frac{a}{2}}^{+ \frac{a}{2}} {dx}_{2} {\int }_{- \frac{b}{2}}^{+ \frac{b}{2}} {dz}_{2} \frac{1}{R} . \qquad ( 27 )$$

such that:

R=\sqrt{(x₁−x₂)²+(z₁−z₂)²+Δ²}. (28)

Defining the dimensionless variables:

$${x}_{1}^{′} = \frac{{x}_{1}}{a} , {z}_{1}^{′} = \frac{{z}_{1}}{b} , {x}_{2}^{′} = \frac{{x}_{2}}{a} , {z}_{2}^{′} = \frac{{z}_{2}}{b} , {R}^{′} = \frac{R}{Δ} , {a}^{′} = \frac{a}{Δ} , {b}^{′} = \frac{b}{Δ} , \qquad ( 29 )$$

gives:

$$\vec{P} = \frac{{μ}_{0}}{4 π} σ {J}_{0} w a {b}^{2} \tilde{Λ} ( {a}^{′} , {b}^{′} ) \hat{x} . \qquad ( 30 )$$

where
\vec{J}₀ is the current density of the charged motor, typically the current density of a current in a conducting coil encircling a charged mass of the charged motor,
μ₀ is the permeability of free space (as defined in the equation

$$c = \frac{1}{\sqrt{{ϵ}_{0} {μ}_{0}}}$$

),
σ is a surface charge density of a charged mass of the relativisitic motor, defined as σ=2ϵE<σₘₐₓ=2ϵEₘₐₓ, where ϵ=ϵᵣϵ₀, where ϵᵣ is a relative susceptibility. (For air and σₘₐₓ≃53 μC/m².)
a and b are dimensions of the charged mass of the relativisitic motor, such as an electret
a′ and b′ are normalized dimensions of a and b, where

$${a}^{′} = \frac{a}{Δ} , {b}^{′} = \frac{b}{Δ} . ,$$

where Δ is the distance of the current plane of the current density \vec{J}₀ from the negative charge plane of the charged mass,
w is the width of the conducting coil,
\hat{x} is a unit vector in the x direction, and
the function \tilde{Λ}(a′,b′) is dimensionless and depends on the dimensionless quantities a′,b′. It can be evaluated using the quadruple integral:

$$\tilde{Λ} ( {a}^{′} , {b}^{′} ) ≡ {\int }_{- \frac{1}{2}}^{+ \frac{1}{2}} {dx}_{1}^{′} {\int }_{- \frac{1}{2}}^{+ \frac{1}{2}} {dz}_{1}^{′} {\int }_{- \frac{1}{2}}^{+ \frac{1}{2}} {dx}_{2}^{′} {\int }_{- \frac{1}{2}}^{+ \frac{1}{2}} {dz}_{2}^{′} \frac{a ′}{R ′} . \qquad ( 31 )$$

in which:

R′=\sqrt{a′²(x′₁−x′₂)²+b′²(z′₁−z′₂)²+1}. (32)

This integration is performed partially analytically, requiring an auxiliary function, as follows:

$$\tilde{Γ} ( {a}^{′} , {b}^{′} , {x}_{2}^{′} , {z}_{2}^{′} ) ≡ {\int }_{- \frac{1}{2}}^{+ \frac{1}{2}} {dx}_{1}^{′} {\int }_{- \frac{1}{2}}^{+ \frac{1}{2}} {dz}_{1}^{′} \frac{a ′}{R ′} \qquad ( 33 )$$

$$⇒ \tilde{Λ} ( {a}^{′} , {b}^{′} ) = {\int }_{- \frac{1}{2}}^{+ \frac{1}{2}} {dx}_{2}^{′} {\int }_{- \frac{1}{2}}^{+ \frac{1}{2}} {dz}_{2}^{′} \tilde{Γ} ( {a}^{′} , {b}^{′} , {x}_{2}^{′} , {z}_{2}^{′} ) .$$

By a change of variables:

x=x′₁−x′₂, z=z′₁−z′₂, (34)

such that:

$$\tilde{Γ} ( {a}^{′} , {b}^{′} , {x}_{2}^{′} , {z}_{2}^{′} ) = {\int }_{- \frac{1}{2} - x {′}_{2}}^{+ \frac{1}{2} - x {′}_{2}} dx {\int }_{- \frac{1}{2} - z {′}_{2}}^{+ \frac{1}{2} - z {′}_{2}} dz \frac{{a}^{′}}{{R}^{′}} \qquad ( 35 )$$

$${R}^{′} = \sqrt{{a}^{′ 2} {x}^{2} + {b}^{′ 2} {z}^{2} + 1} .$$

Defining a second function provides an analytic solution:

$$Ψ ( {a}^{′} , {b}^{′} , {x}_{2}^{′} , {z}_{2}^{′} ) ≡ {\int }_{- \frac{1}{2} - {z}_{2}^{′}}^{+ \frac{1}{2} - {z}_{2}^{′}} dz \frac{{a}^{′}}{{R}^{′}} \qquad ( 36 )$$

$$⇒ \tilde{Γ} ( {a}^{′} , {b}^{′} , {x}_{2}^{′} , {z}_{2}^{′} ) = {\int }_{- \frac{1}{2} - x {′}_{2}}^{+ \frac{1}{2} - x {′}_{2}} dx Ψ ( {a}^{′} , {b}^{′} , x , {z}_{2}^{′} ) .$$

The function Ψ can be integrated analytically by introducing the new variable:

$${z}^{″} = \frac{b}{a} \frac{z}{\sqrt{{x}^{2} + {a}^{′ - 2}}} , \qquad ( 37 )$$

in terms of which:

$$Ψ ( {a}^{′} , {b}^{′} , {x}_{2}^{′} , {z}_{2}^{′} ) = \frac{a}{b} {\int }_{z {″}_{1}}^{z {″}_{2}} {dz}^{″} \frac{1}{\sqrt{1 + z {″}^{2}}} = \frac{a}{b} [ arc sinh ( {z}_{2}^{″} ) - arc sinh ( {z}_{1}^{″} ) ] , \qquad ( 38 )$$

$$\begin{matrix}{z}_{1}^{″} = \frac{b}{a} ( \frac{- \frac{1}{2} - z {′}_{2}}{\sqrt{{x}^{2} + {a}^{′ - 2}}} ) , & {z}_{2}^{″} = \frac{b}{a} ( \frac{- \frac{1}{2} - z {′}_{2}}{\sqrt{{x}^{2} + {a}^{′ - 2}}} )\end{matrix} .$$

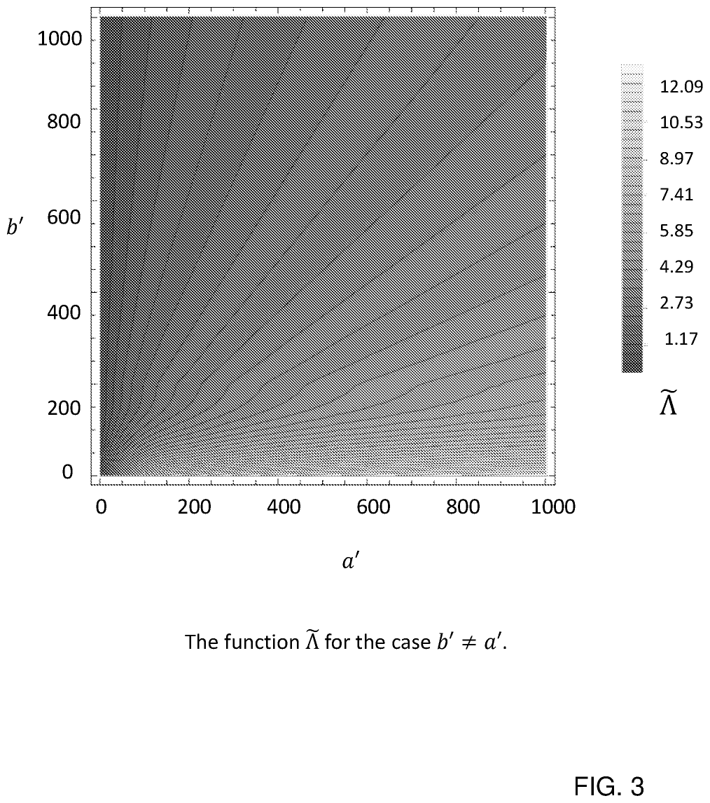

The calculation of \tilde{Γ} and \tilde{Λ} can only be done numerically. For the case b′=a′ the function \tilde{Λ} is a single variable function depicted in FIG. 2. It can be seen that for a′=0 the function is null, while for a′ approaches ∞ the function approaches 2.973˜3. Hence if the ratio of the size of the engine to the winding width is about 20 and d˜a, one does not lose a significant amount of force and momentum due to the return current.

The graph of \tilde{Λ} for the case b′≠a′, depicted in FIG. 3, shows that there is an obvious advantage for a slender charged motor in the direction of motion, i.e., a motor in which in the a′ is large with respect to b′ and to d.

As current flows in the direction indicated by \vec{J}₀, a momentum in the x direction is generated. As mentioned above, the return current interacts symmetrically with the positive charge in a beneficial way, as both the sign of the charge and the direction of the current are reversed, thereby doubling the momentum gain such that according to equation (30) gives:

$${\vec{P}}_{T} = \frac{{μ}_{0}}{2 π} σ {J}_{0} w a {b}^{2} ( \tilde{Λ} ( \frac{a}{{Δ}_{1}} , \frac{b}{{Δ}_{1}} ) - \tilde{Λ} ( \frac{a}{{Δ}_{2}} , \frac{b}{{Δ}_{2}} ) ) \hat{x} \qquad ( 39 )$$

$$where :$$

$$\begin{matrix}{Δ}_{1} = \frac{w}{2} , & {Δ}_{2} = \frac{w}{2} + d .\end{matrix} \qquad ( 40 )$$

The force produced by the charged motor depends on the rise time of the current which can be increased gently or abruptly:

$${\vec{F}}_{T} = \frac{d {\vec{P}}_{T}}{dt} = \frac{{μ}_{0}}{2 π} σ \frac{d {J}_{0}}{dt} w a {b}^{2} ( \tilde{Λ} ( \frac{a}{{Δ}_{1}} , \frac{b}{{Δ}_{1}} ) - \tilde{Λ} ( \frac{a}{{Δ}_{2}} , \frac{b}{{Δ}_{2}} ) ) \hat{x} . \qquad ( 41 )$$

As indicated by the equation, the application of a rapidly increased current imposes a large force on the charged motor, causing a sudden movement in a vehicle to which the charge motor is affixed. This means that, for example, when the charged motor is affixed to a space vehicle, a large current may be rapidly applied to steer the space vehicle clear of an approaching object, thereby avoiding a collision.

Different configurations of a charged motor may be designed. For example, a motor having a size of standard car, with parameters as described in the first column of the following table, gives a momentum of 0.3 kg m/s. A motor having a size considerably larger, which may be suitable for a space vehicle, with parameters as given in the second column of the following table, provides a momentum of 868 kg m/s.

| | car-sized | space vehicle | |
|---|---|---|---|
| | engine | sized engine | units |
| a | 6 | 200 | m |
| b | 2 | 10 | m |
| d | 1 | 10 | m |
| w | 0.2 | 0.4 | m |
| P_{T} | 0.3 | 868 | kg m/s |

The table shows the maximal momentum gained by a charged motor for two cases of parameters. The momemtum indicated is based on a charge density σ=3.7×10⁻³ Coulomb/m², and a current density J₀=5×10⁷ Ampere/m².

### The Nano Relativistic Motor

Dielectric breakdown limits the momentum that can be gained by the charged motor. In the microscopic domain, this limitation is less restrictive. For example, for ionic crystals such as in table salt: Na⁺Cl⁻, the crystal solidifies to a face centered cubic lattice in which the lattice constant is l=564.02 pm. Taking for example the 100 plane of this lattice, the charge density is periodic, with each half unit cell having a surface charge density of ±2 Coulomb/m². This is a thousand time larger than available macroscopic charge densities, as described above. However, on the macroscopic scale, the average charge density is null. To circumvent this situation, the periodic charge density of the crystal must be accompanied by a current density distribution of the same period, as described below.

To determine this periodicity, first note that from equation (19), the spatial Fourier transform of the scalar potential and the current density may be represented as:

Φ₁(\vec{k})=∫_{-∞}^{+∞}∫_{-∞}^{+∞}∫_{-∞}^{+∞}Φ₁(\vec{x})e^{i\vec{k}·\vec{x}}d³x,

\vec{J}₂(\vec{k})=∫_{-∞}^{+∞}∫_{-∞}^{+∞}∫_{-∞}^{+∞}\vec{J}₂(\vec{x})e^{-i\vec{k}·\vec{x}}d³x. (42)

Using the theorem of Parseval [Ref. 23], equation (19) may take the form:

$$\vec{P} ( t ) = - \frac{1}{{{c}^{2} ( 2 π )}^{3}} {\int }_{- ∞}^{+ ∞} {\int }_{- ∞}^{+ ∞} {\int }_{- ∞}^{+ ∞} {d}^{3} k {Φ}_{1}^{*} ( \vec{k} ) {\vec{J}}_{2} ( \vec{k} ) \qquad ( 43 )$$

In this form it is obvious that a microscopic distribution of periodic charge density will be beneficial if it is a accompanied by a current density distribution of the same period. Microscopic currents are associated with the electronic motion and electronic spin. The magnetization \vec{M} is related to the magnetization current \vec{J}_{M} by the formulae of Maxwell [Refs. 2, 3]:

\vec{J}_{M}≡\vec{∇}×\vec{M}. (44)

Microscopic distribution of periodic charge density may therefore be beneficial if it is a accompanied by a current density distribution of the same period. Replace \vec{J} in equation (18), equation (19) and equation (43) by \vec{J}_{M} to obtain a similar effect. Furthermore, the magnetization \vec{M} is related to microscopic dipole moments \vec{m}ᵢ through:

$$\vec{M} ≡ \frac{1}{V} {\sum }_{i} {\vec{m}}_{i} . \qquad ( 45 )$$

that is, summing over all dipoles and dividing by the sample volume V. In known magnetic materials such as iron the magnetic dipole moments are related to the spin configuration of the atom. In α-iron the spins of the two unpaired electrons in each atom generally align with the spins of its neighbors. This happens because the orbitals of those two electrons (d_{z}_{²} and dₓ_{²}_{-y}_{²}) do not point toward neighboring atoms in the lattice, and therefore are not involved in metallic bonding. Hence an improved configuration for a charged motor involves an ionic lattice in which one species of atom (say the positively charged) involves free spins that can be manipulated by an external magnetic field. This creates a relativistic engine effect that can be manipulated in three axes. This is just one example for manipulating charge densities and current densities at the microscopic scale, however, charge and current densities can be manipulated in the microscopic scale using diverse electromagnetic and chemical techniques which are not precluded by the above example.

The aforementioned diagrams illustrate the architecture, functionality, and operation of possible implementations of systems and methods of the present invention. In the above description, an embodiment is an example or implementation of the invention. The various terms related to “embodiments” or “some embodiments” above do not necessarily refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Method steps associated with the system and process can be rearranged and/or one or more such steps can be omitted to achieve the same, or similar, results to those described herein. It is to be understood that the embodiments described hereinabove are cited by way of example, and that the present invention is not limited to what has been particularly shown and described hereinabove. Rather, the scope of the present invention includes variations and modifications thereof which would occur to persons skilled in the art upon reading the foregoing description and which are not disclosed in the prior art.

### REFERENCES

The following references, cited in the description above, are hereby included by reference in their entirety:
[Ref. 1] Miron Tuval & Asher Yahalom, “Newton's Third Law in the Framework of Special Relativity,” Eur. Phys. J. Plus, (11 Nov. 2014) 129: 240 DOI: 10.1140/epjp/i2014-14240-x. (arXiv:1302.2537 [physics.gen-ph]).
[Ref. 2] Miron Tuval and Asher Yahalom, “A Permanent Magnet Relativistic Engine,” Proceedings of the Ninth International Conference on Materials Technologies and Modeling, (MMT-2016) Ariel University, Ariel, Israel, Jul. 25-29, 2016.
[Ref. 3] Asher Yahalom, “Retardation in Special Relativity and the Design of a Relativistic Motor,” Acta Physica Polonica A, Vol. 131 (2017) No. 5, 1285-1288. DOI: 10.12693/APhysPolA.131.1285
[Ref. 4] Miron Tuval and Asher Yahalom, “Momentum Conservation in a Relativistic Engine,” Eur. Phys. J. Plus (2016) 131: 374. DOI: 10.1140/epjp/i2016-16374-1
[Ref. 5] Asher Yahalom, “Preliminary Energy Considerations in a Relativistic Engine,” Proceedings of the Israeli-Russian Bi-National Workshop “The optimization of composition, structure and properties of metals, oxides, composites, nano- and amorphous materials”, page 203-213, 28-31 Aug. 2017, Ariel, Israel.
[Ref. 6] S. Rajput and A. Yahalom, “Preliminary Magnetic Energy Considerations in a Relativistic Engine: Mutual Inductance vs. Kinetic Terms,” 2018 IEEE International Conference on the Science of Electrical Engineering in Israel (ICSEE), Eilat, Israel, 2018, pp. 1-5. doi: 10.1109/ICSEE.2018.8646265
[Ref. 7] S. Rajput and A. Yahalom, “Material Engineering and Design of a Relativistic Engine: How to Avoid Radiation Losses,” Advanced Engineering Forum ISSN: 2234-991X, Vol. 36, pp 126-131. Submitted: 2019 Jun. 16, Accepted: 2020 May 18, Online: 2020 Jun. 17. ©2020 Trans Tech Publications Ltd, Switzerland.
[Ref. 8] A. Einstein, “On the Electrodynamics of Moving Bodies,” Annalen der Physik 17 (10): 891921, (1905).
[Ref. 9] J.C. Maxwell, “A dynamical theory of the electromagnetic field” Philosophical Transactions of the Royal Society of London 155: 459512, (1865).
[Ref. 10] J. D. Jackson, Classical Electrodynamics, Third Edition, Wiley: New York, (1999).
[Ref. 11] R. P. Feynman, R. B. Leighton & M. L. Sands, “Feynman Lectures on Physics,” Basic Books; revised 50th anniversary edition (2011).
[Ref. 12] O. Heaviside, “On the Electromagnetic Effects due to the Motion of Electrification through a Dielectric,” Philosophical Magazine, (1889).
[Ref. 13] I. Newton, “Philosophiae Naturalis Principia Mathematica” (1687).
[Ref. 14] H. Goldstein , C. P. Poole Jr. & J. L. Safko, Classical Mechanics, Pearson; 3 edition (2001).
[Ref. 15] M. Mansuripur, “Trouble with the Lorentz Law of Force: Incompatibility with Special Relativity and Momentum Conservation” PRL 108, 193901 (2012).
[Ref. 16] D. J. Griffiths & M. A. Heald, “Time dependent generalizations of the Biot-Savart and Coulomb laws,” American Journal of Physics, 59, 111117 (1991), DOI:http://dx.doi.org/10.1119/1.16589.
[Ref. 17] Jefimenko, O. D., Electricity and Magnetism, Appleton-Century Crofts, New York (1966); 2nd edition, Electret Scientific, Star City, WV (1989).
[Ref. 18] Dielectric Strength of Air—the Physics Fact Book, https://hypertextbook.com/facts/2000/AliceHong.shtml.
[Ref. 19] Stefan Giere, Michael Kurrat & Ulf Schumann, “HV Dielectric Strength of Shielding Electrodes in Vacuum Circuit-Breakers,” 20th International Symposium on Discharges and Electrical Insulation in Vacuum—Tours, France—Jun. 30-Jul. 5, 2002.
[Ref. 20] Markus Gabrysch, “Electronic properties of diamond,” el.angstrom.uu.se. Retrieved 2013 Aug. 10.
[Ref. 21] L. Hsi-wen, T. Yu-Chong, “Parylene-based electret power generators,” J. Micromech. Microeng. 18 (10) (2008) 104006.
[Ref. 22] Jung, S.-G. et al., “Enhanced critical current density in the pressure induced magnetic state of the high-temperature superconductor,” FeSe. Sci. Rep. 5, 16385; doi: 10.1038/srep16385 (2015).
[Ref. 23] Peebles, P. Z., Probability, Random Variables and Random Signal Principles, McGraw Hill, New York, NY, USA (2001).

1. A charged motor comprising a first element, having a non-zero charge density ρ₁, and a second element having a non-zero current density \vec{J}₂, wherein the first and second elements have respective volume locations \vec{x}₁ and \vec{x}₂, charge densities ρ₁ and ρ₂, and current densities \vec{J}₁ and \vec{J}₂, wherein the first element is a charged electret and the second element is a conducting coil wrapped around the first element, wherein the charge densities and the current densities interact, generating a force \vec{F}_{T}:
$${\vec{F}}_{T} ≅ \frac{{μ}_{0}}{4 π} {\partial }_{t} \int \int {d}^{3} {x}_{1} {d}^{3} {x}_{2} [ \frac{1}{2} ( {ρ}_{2} {\partial }_{t} {ρ}_{1} - {ρ}_{1} {\partial }_{t} {ρ}_{2} ) \hat{R} - ( {ρ}_{1} {\vec{J}}_{2} + {ρ}_{2} {\vec{J}}_{1} ) {R}^{- 1} ] ,$$
$$where \vec{R} ≡ {\vec{x}}_{12} = {\vec{x}}_{1} - {\vec{x}}_{2} , R ≡ \vert {\vec{x}}_{1} - {\vec{x}}_{2} \vert , \hat{R} ≡ \vec{\frac{R}{R}} ,$$
and μ₀ is the permeability of free space.

2. The charged motor of claim 1, wherein the charged motor has perpendicular x, y, and z axes, wherein a charge gradient extends along the y axis from a negative charge on a first side to a positive charge on a second side of the charged electret, wherein the coil is wrapped in planes of the x and y axes, and is further configured to receive the current density such that a current flows, on the first side with the negative charge, in the direction of the x axis, and, on the second side with the positive charge, against the direction of the x axis, the force being generated in the direction of x axis.

3. The charged motor of claim 2, wherein the second element is a superconducting coil and wherein the current density \vec{J}₂ is set to a maximum current density obtainable by the superconducting coil.

4. The charged motor of claim 1, wherein the current density is set to approximately 5 kA/cm².

5. The charged motor of claim 1, wherein the charge density ρ₁ is set to a maximum charge density obtainable without dielectric breakdown.

6. The charged motor of claim 1, wherein the charged electret comprises fluorinated parylene.

7. The charged motor of claim 1, wherein a momentum \vec{P}(t) acquired by the charged motor is given by the equation:
$$\vec{P} ( t ) = - \frac{{μ}_{0}}{4 π} \int \int {d}^{3} {x}_{1} {d}^{3} {x}_{2} {ρ}_{1} {\vec{J}}_{2} {R}^{- 1} .$$

8. The charged motor of claim 1, wherein the first element is a microscopic element.

9. A vehicle configured for ground, sea, air and/or space travel comprising a charged motor having a first element having a non-zero charge density ρ₁, a second element having a non-zero current density \vec{J}₂, wherein the charged motor has perpendicular x, y, and z axes, wherein a charge gradient of the charge density extends along the y axis from a negative charge on a first side to a positive charge on a second side of the first element, wherein the second element is a coil wrapped around the first element in planes of the x and y axes, and is further configured to receive the current density such that a current flows, on the first side with the negative charge, in the direction of the x axis, and, on the second side with the positive charge, against the direction of the x axis, a force \vec{F}_{T} for propelling the vehicle being generated in the direction of the x axis and given by the equation:
$${\vec{F}}_{T} ≅ \frac{{μ}_{0}}{4 π} {\partial }_{t} \int \int {d}^{3} {x}_{1} {d}^{3} {x}_{2} [ \frac{1}{2} ( {ρ}_{2} {\partial }_{t} {ρ}_{1} - {ρ}_{1} {\partial }_{t} {ρ}_{2} ) \hat{R} - ( {ρ}_{1} {\vec{J}}_{2} + {ρ}_{2} {\vec{J}}_{1} ) {R}^{- 1} ] ,$$
wherein the first and second elements have respective volume locations \vec{x}₁ and \vec{x}₂, charge densities ρ₁ and ρ₂, and current densities \vec{J}₁ and \vec{J}₂, wherein \vec{R}≡\vec{x}₁₂=\vec{x}₁−\vec{x}₂, R≡|\vec{x}₁−\vec{x}₂|,
$$\hat{R} ≡ \vec{\frac{R}{R}} ,$$
and wherein μ₀ is the permeability of free space.

10. The vehicle of claim 9, further comprising a photoelectric panel and a battery, wherein the first element is a charged electret plate, the second element is a conductive coil wound around the electret plate, wherein the current density \vec{J}₂ is generated in the conductive coil, wherein the photoelectric panel is a power source for the battery, and wherein the battery provides the current density.

11. The vehicle of claim 9, wherein the second element is a superconducting coil.

12. The vehicle of claim 9, wherein the second element is a superconducting coil and wherein the current density \vec{J}₂ is set to a maximum current density obtainable by the superconducting coil.

13. The vehicle of claim 9, wherein the current density is set to approximately 5 kA/cm².

14. The vehicle of claim 9, wherein the charge density ρ₁ is set to a maximum charge density obtainable without dielectric breakdown.

15. The vehicle of claim 9, wherein the first element comprises fluorinated parylene and the charge density imposed on the first element is approximately 3.7 mC/m².

16. The vehicle of claim 9, wherein the first element is a charged electret and wherein the second element is a conducting coil wrapped around the first element.

17. A method for space vehicle propulsion comprising:
providing a charged electret, having a charge gradient and wrapped by a conducting coil, as an integral element of a vehicle;
providing a current to the conducting coil to generate in the conducting coil a current density of \vec{J}₀, to cause the vehicle to have a momentum proportional to the current density.

18. The method of claim 17, wherein the momentum is approximately:
$${\vec{P}}_{T} = \frac{{μ}_{0}}{2 π} σ {J}_{0} w a {b}^{2} ( \tilde{Λ} ( \frac{a}{{Δ}_{1}} , \frac{b}{{Δ}_{1}} ) - \tilde{Λ} ( \frac{a}{{Δ}_{2}} , \frac{b}{{Δ}_{2}} ) ) \hat{x}$$
$$where \qquad {Δ}_{1} = \frac{w}{2} , \qquad {Δ}_{2} = \frac{w}{2} + d , \qquad {μ}_{0}$$
where the coil is wrapped in planes of the dimensions of d and a, where d is the dimension of the electret in the axis of the charge gradient, b is the dimension of the electret in the axis around which the coil is wrapped, a is perpendicular to dimensions d and b, w is the thickness of the coil, and \tilde{Λ} is derived analytically from a and b, with values indicated in the graph of FIG. 3.

19. The method of claim 18, wherein the force applied by the charged motor on the vehicle is in the direction of the dimension of a, and is approximately:
$${\vec{F}}_{T} = \frac{{μ}_{0}}{2 π} σ \frac{d {J}_{0}}{dt} w a {b}^{2} ( \tilde{Λ} ( \frac{a}{{Δ}_{1}} , \frac{b}{{Δ}_{1}} ) - \tilde{Λ} ( \frac{a}{{Δ}_{2}} , \frac{b}{{Δ}_{2}} ) ) \hat{x} .$$
